(19) United States
(12) Patent Application Publication
(10) Pub. No.: US 2025/0292519 A1
(43) Pub. Date: Sep. 18, 2025

(54) AUGMENTED REALITY FEEDBACK IN USER INTERFACES FOR DIMENSIONING OBJECTS

(71) Applicant: QBOID, INC., San Jose, CA (US)

(72) Inventors: Francesco PERUCH, Sunnyvale, CA (US); Davide ZANELLA, Padua (IT); Bin AN, Saratoga, CA (US); Tony ZUCCARINO, Scottsdale, AZ (US)

(21) Appl. No.: 19/076,755

(22) Filed: Mar. 11, 2025

Related U.S. Application Data
(60) Provisional application No. 63/566,171, filed on Mar. 15, 2024.

(51) Int. Cl. G06T 19/00; G06T 7/50; G06T 15/00

(52) U.S. Cl. CPC G06T 19/006; G06T 7/50; G06T 15/00; G06T 2207/10028

(57) ABSTRACT

A system includes: a depth reconstruction system; a display device; a processor; and memory storing instructions that when executed by the processor, cause the processor to: control the depth reconstruction system to capture a three-dimensional representation of a scene; perform automatic object detection on the three-dimensional representation of the scene; detect a ground plane in the scene; render a model of the ground plane in a live view image of the scene; perform detection of problems in a framing of the scene in a field of view of the depth reconstruction system; and display, on the display device, the live view image of the scene augmented with the rendered model of the ground plane and one or more detected framing problems.

### CROSS-REFERENCE TO RELATED APPLICATION(S)

This application claims the benefit of U.S. provisional patent application 63/566,171 titled “AUGMENTED REALITY FEEDBACK IN USER INTERFACES FOR DIMENSIONING OBJECTS” filed in the United States Patent and Trademark Office on Mar. 15, 2024, the entire disclosure of which is incorporated by reference herein.

### FIELD

Aspects of embodiments of the present disclosure relate to user interfaces and methods associated therewith for a contactless measurement device. In more detail, some aspects relate to user interfaces for providing feedback to a user in an augmented reality display when measuring the dimensions of an object.

### BACKGROUND

Various industries perform dimensioning of objects in day-to-day operations. For example, logistics businesses and/or package shipping businesses compute the dimensions of objects, which may be irregularly shaped, to determine how to package those objects, such as in the smallest available box that will hold the object, or to determine the pricing for shipping a box with particular dimensions.

The above information disclosed in this Background section is only for enhancement of understanding of the present disclosure, and therefore it may contain information that does not form the prior art that is already known to a person of ordinary skill in the art.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, together with the specification, illustrate exemplary embodiments of the present invention, and, together with the description, serve to explain the principles of the present invention.

FIG. 1A is a schematic diagram of a handheld, contactless dimensioning device implementing a user interface, according to some embodiments of the present disclosure.

FIG. 1B is a block diagram illustrating a dimensioning device, according to one embodiment of the present disclosure.

FIG. 2 is a flowchart of a method for providing user feedback regarding the relative position between scanning device and an object to be dimensioned, according to some embodiments of the present disclosure.

FIGS. 3A, 3B, and 3C are screenshots depicting a live view portion of a user interface for a dimensioning device according to one embodiment of the present disclosure, where the user interface shows a rendered grid corresponding to a detected ground plane and a rendered object corresponding to a detected object on the ground plane.

FIG. 4 is a screenshot of a user interface, according to one embodiment of the present disclosure, where the user interface shows uneven transparency of a rendered grid, representing different levels of certainty regarding the detection of a ground plane.

FIGS. 5A, 5B, 5C, and 5D depict user interfaces, according to some embodiments of the present disclosure, with respective examples of instances where an object is framed acceptably based on distance, framed acceptably but with warnings based on being too distant from the object, framed unacceptably based on being too distant from the object, and framed unacceptably based on being too close to the object.

FIG. 6 depicts a user interface, according to some embodiments of the present disclosure, displaying error feedback when an object is framed too close to edges of the field of view of the scanning device.

FIGS. 7A and 7B depict user interfaces, according to some embodiments of the present disclosure in which accuracy of scanning is improved when scanning the object from above, where an object is framed acceptably but with warnings due to a low angle and where an object is framed unacceptably due to a low angle.

FIG. 8 depicts a user interface, according to some embodiments of the present disclosure, where feedback is provided to the user in a case where no object is detected in the field of view of the scanning device.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein.

Aspects of embodiments of the present disclosure relate to contactless object dimensioning systems having user interfaces, such as augmented reality user interfaces, that provide feedback or guidance to the user. Where some techniques for measuring the dimensions of objects involve physical contact with an object, such as through the use of a ruler, a tape measure, calipers, or the like, a contactless object dimensioning system may use techniques based on, for example, electromagnetic radiation (e.g., visible light, infrared light, etc.) to measure the dimensions of objects. One illustrative example described herein relates to the use of a depth reconstruction system that captures one or more images of an object in its field of view (e.g., based on light reflected by the object) and computes the dimensions of the object based on those images.

In some contactless object dimensioning systems, the accuracy of the computed dimensions depends on capturing high quality images of the object. This may include ensuring that the object is located within the field of view of the contactless object dimensioning system and that the object is oriented in a manner that reduces or minimizes ambiguity due to occlusion (e.g., where the shape of part of the object is hidden by another object in the scene or the same object in the scene). However, the limitations of the sensors used by the contactless object dimensioning system are opaque (e.g., not apparent) to a user, such that the user may be confused as to why the contactless object dimensioning system might be computing inaccurate dimensions of an object or failing to compute dimensions at all. In these circumstances, it may also be difficult for a user to determine how to change their processes for scanning the object to improve the performance of the contactless object dimensioning system, which may reduce throughput in high-volume activities such as logistics (e.g., shipping of goods).

Accordingly, aspects of the present disclosure relate to providing feedback or guidance to the user to adjust the relative positions and orientations (or poses) of the object being measured and the contactless object dimensioning system to capture higher quality data for computing the dimensions of the object. In some embodiments, a display device associated with the contactless object dimensioning system provides a live view of the scene that is within the field of view of the contactless dimensioning device and augments this live view with feedback. In various embodiments, this feedback includes a highlighting of the portions of the scene that contain the object that is being dimensioned (e.g., feedback regarding whether the system has detected the correct object and detected the object in its entirety), feedback regarding the computed ground plane that the object is resting on, feedback regarding whether the object is correctly framed within the field of view of the contactless object dimensioning system (e.g., not extending outside of the field of view), feedback regarding the distance to the object (e.g., whether the user should get closer to the object or move farther away), and feedback regarding whether the contactless object dimensioning system is properly oriented (e.g., in some circumstances, the contactless object dimensioning system generates more accurate dimensions when located above the object and capturing a top-down view).

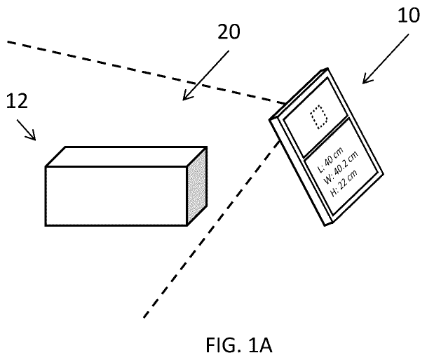

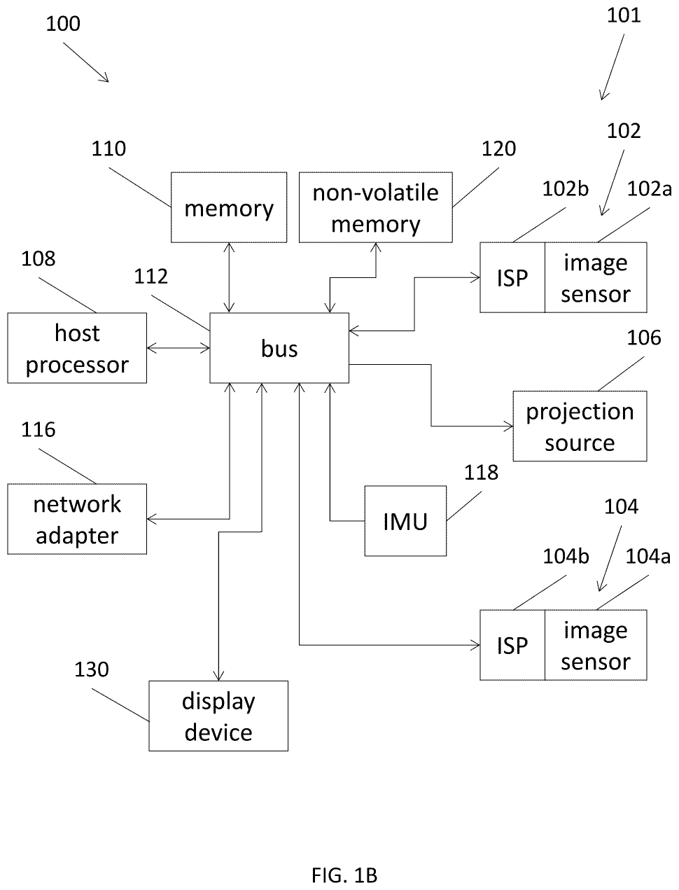

FIG. 1A is a schematic diagram of a handheld, contactless dimensioning device implementing a user interface according to some embodiments of the present disclosure. The dimensioning device 10 may include a processor (or processing circuit) and memory storing instructions that configure the processor to perform operations in accordance with various embodiments of the present disclosure.

As shown in FIG. 1A, the dimensioning device 10 may be used by an operator (e.g., held by a human user) to capture the physical dimensions (e.g., length, width, and height) of an object of interest 12 within a field of view 20 of the dimensioning device 10.

For example, the field of view 20 of the dimensioning device 10 may be set by a depth reconstruction system incorporated into the dimensioning device 10, where the depth reconstruction system captures a three-dimensional representation of surfaces within the field of view 20. For example, in cases where the depth reconstruction system includes a depth camera system, the depth camera system may compute a depth map (or depth image) where each pixel in the depth map is an estimate of the distance from the depth camera system to the depicted surface in the field of view 20. The location of each pixel in the depth map corresponds to an angle between the optical axis of the depth camera system and the surface within the field of view 20 that is imaged by that pixel. Therefore, the depth map can be mathematically transformed directly into a collection of three-dimensional (3-D) points (e.g., having x, y, and z coordinates), where such a collection of 3-D points may be referred to as a point cloud. In some embodiments, the depth camera system captures a 3-D mesh model of the scene (e.g., by connecting the 3-D points of the point cloud), which represents the surfaces of objects in the scene based on vertices and surfaces (e.g., triangular planes) connecting the vertices. Accordingly, a depth camera system can capture 3-D representation of surfaces of objects in the field of view 20, where the representation may be in the form of a point cloud, a 3-D mesh model, or other representation of 3-D shapes. In the case of a depth camera system, the field of view 20 (e.g., a solid angle) is controlled by the optical characteristics of one or more lenses of the depth camera system. For example, in the case of a stereo depth camera system that includes a plurality of cameras, the field of view may correspond to a region in which the fields of view of the cameras overlap. Some examples of systems and methods for computing dimensions of objects based on collections of 3-D points captured by a depth reconstruction system are described in U.S. patent application Ser. No. 18/124,785, filed on Mar. 22, 2023, published on Sep. 28, 2023 as U.S. Patent Application Publication No. 2023/0306625, the entire disclosure of which is incorporated by reference herein.

FIG. 1B is a block diagram illustrating a dimensioning device 100 according to one embodiment of the present disclosure. The dimensioning device 100 shown in FIG. 1B includes a depth reconstruction system 101 that includes a depth camera system that includes a first camera 102, a second camera 104, a projection source 106 (or illumination source or active projection system).

The dimensioning device 100 shown in FIG. 1B also includes a host processor 108 and memory 110, wherein the host processor may include, for example, a graphics processing unit (GPU), a central processing unit (CPU), a system on chip (SoC), an application processor (AP), an appropriately configured field programmable gate array (FPGA), and/or an application specific integrated circuit (ASIC). The first camera 102 and the second camera 104 may be rigidly attached, e.g., on a frame, such that their relative positions and orientations are substantially fixed. The first camera 102 and the second camera 104 include corresponding image sensors 102a and 104a and may also include corresponding image signal processors (ISP) 102b and 104b. The various components may communicate with one another over a system bus 112. The dimensioning device 100 may include additional components such as a network adapter 116 to communicate with other devices, an inertial measurement unit (IMU) 118 including sensors such as a gyroscope and/or an accelerometer to detect acceleration of the dimensioning device 100 (e.g., detecting the direction of gravity to determine orientation), non-volatile memory 120 (or non-transitory memory or persistent memory) such as NAND flash memory for storing data collected and processed by the dimensioning device 100, and a display device 130 for displaying a user interface and, in embodiments where the display device 130 is a touch-sensitive display device (e.g., a touchscreen), for receiving user input. The IMU 118 may be of the type commonly found in many modern smartphones. The dimensioning device 100 may also include other communication components, such as a universal serial bus (USB) interface controller, a wireless network interface controller (e.g., Bluetooth® Low Energy, Wi-Fi, and the like).

Examples of depth camera systems include, but are not limited to, structured light depth cameras, active stereo depth camera systems (which include active light sources) as shown in the example of FIG. 1B, passive stereo depth camera system (which do not include active light sources, such as by omitting the projection source 106 shown in FIG. 1B), time of flight depth cameras, and the like. However, embodiments of the present disclosure are not limited to the use of depth camera systems for performing depth reconstruction. In some embodiments, depth reconstruction systems implement one or more techniques in accordance with: Structure from Motion, Machine Learning approaches (e.g., a neural network trained to compute depth maps from a stereo pair of images or from a single image), Depth from Defocus, etc., or full 3D reconstruction of an entire scene like simultaneous localization and mapping (SLAM).

In some embodiments of the present disclosure, the image sensors of the depth reconstruction system 101 (e.g., image sensor 102a and image sensor 104b) may be visible light image sensors or infrared image sensors. In embodiments of the present disclosure that include an active light projection source (e.g., projection source 106), the projection source is configured to emit light in a wavelength that falls within a detection range of the image sensors. For example, a visible light image sensor (e.g., with a red, green, and blue color filter array in an arrangement such as a Bayer filter mosaic) may be paired with a visible light projection source (e.g., emitting white light across a broad spectrum or a combination of red, green, and blue light) or an infrared image sensor may be paired with an infrared light emitting device (e.g., about 840 nm-860 nm in the near-infrared range).

Aspects of embodiments of the present disclosure relate to user interfaces that provide augmented reality feedback to a user operating a dimensioning device or contactless object dimensioning system. Augmented reality refers to the combination of real-world and computer-generated content. In embodiments of the present disclosure, the combination relates to combining the live view of images of the scene 20 (images captured by a camera such as first camera 102 of the depth reconstruction system) with renderings of models of the scene 20, as automatically computed by the contactless object dimensioning system 100 (e.g., by a processor 108), and displaying the augmented images on a display device 130 of the contactless object dimensioning system 100 to provide feedback to the user regarding the current interpretation of the scene by the contactless object dimensioning system. This feedback may include showing which object is currently detected as the object to be measured and the location of the ground plane relative to the object, as discussed in more detail below.

In an augmented reality user interface, these images may be modified in a manner consistent with the movement of the camera 102 through the scene, such as by displaying the detected location of the ground plane in the live view in a manner where the rendered ground plane appears to get closer when the camera moves closer to the actual ground, the rendered ground plane appears to move farther away as the camera moves away from the actual ground, and the rendered ground plane tilts with the actual ground as the camera is tilted.

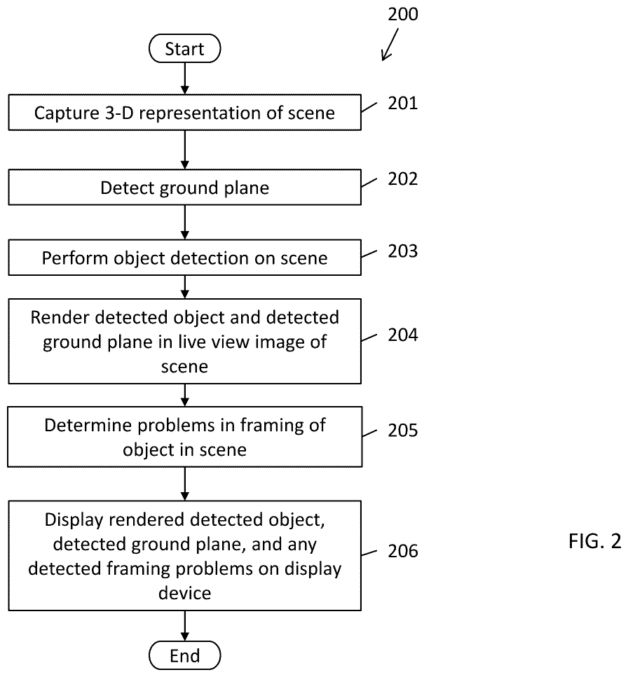

FIG. 2 is a flowchart of a method 200 for providing user feedback regarding the relative position between scanning device and an object to be dimensioned, according to some embodiments of the present disclosure. While the embodiment shown in FIG. 1A has a scanning device (e.g., the depth reconstruction system) that is integrated with a display device that displays a live view of the scene that is captured by the scanning device, embodiments of the present disclosure are not limited thereto and the scanning device may be separate from the display device and other components of the dimensioning system 100 shown in FIG. 1B. For example, a scanning device or module may include the depth reconstruction system 101 and may communicate with other components of the depth reconstruction system over a communication link (e.g., wired or wireless connection).

At 201, the processing circuit controls a scanning device (e.g., the depth reconstruction system) to capture a 3-D representation of a scene, which may contain an object to be dimensioned.

At 202, the processing circuit detects a ground plane supporting the object. In some embodiments, a ground plane may be detected based on identifying points in the depth map or point cloud that are not part of the object and that all within a plane (a flat surface) that is adjacent to the object. In embodiments where the contactless object dimensioning system includes an accelerometer or inertial measurement unit 118, the IMU 118 may be used to estimate a direction of gravity and the plane is determined to be substantially perpendicular to the direction of gravity (accounting for errors in the IMU data, errors in the accuracy of the depth map, sloping in the actual ground plane, and the like). In some embodiments, using the IMU assists in distinguishing between the actual ground plane and a vertical wall within the field of view of the depth reconstruction system.

Some examples of techniques for detecting planes in a point cloud or depth data include a Hough transform, random sample consensus (RANSAC), region growing, and machine learning (ML) approaches (e.g., based on trained neural networks such as convolutional neural networks).

In some embodiments of the present disclosure, the computer system detects a single, large plane that supports one or more objects in the scene. This is simpler than the general case that attempts to identify all planes in the scene.

In some embodiments of the present disclosure, the computer system implements RANSAC. In more detail, in some embodiments, the computer system randomly selects three points in the captured depth map of the scene, which produces a candidate plane equation. The computer system then assesses how many other points in the scene are consistent with this candidate equation. If enough points match it, then a plane is detected in the scene. This process is repeated multiple times to generate a list of candidate planes.

The computer system then selects one of the candidate planes using certain rules and/or heuristics. In some embodiments, the computer system prioritizes selecting larger planes (discarding the smaller planes detected in the scene), planes with normals (lines that are perpendicular to the plane) that are parallel to gravity, and planes that have something on top (for example, if you are viewing a large box from above, the top of the box is a very large horizontal plane, but it is not a good candidate for the ground since there is nothing on top of it, but the floor that the large box rests on is a good candidate because the large box projects out from the plane of that floor).

At 203, the processing circuit attempts to detect an object in the scene. After capturing a depth map (or depth or point cloud) of the scene within the field of view 20 of the depth reconstruction system, the dimensioning device 10 may determine the object of interest to be dimensioned and separate the pixels (or points of the point cloud or vertices and surfaces of a mesh) associated with that object of interest from the other surfaces in the scene. This process of separating pixels associated with the object of interest from other pixels in the depth map may be referred to as segmenting the object from the depth map.

One technique for segmenting the object of interest is to select contiguous groups of points that are above the identified ground plane (e.g., have a different position than the ground plane along the normal direction of that ground plane). In a case where there are multiple groups of points above the identified ground plane, then the group of points closest to (or overlapping) a center of the field-of-view may be automatically selected as the points corresponding to the object of interest.

Another technique that may be used to refine the detection of the object may be to apply a convolutional neural network (CNN) trained to perform instance segmentation on an image (e.g., color image) of the scene or view 20 in order to generate an instance segmentation mask, which identifies the pixels associated with different objects in the scene. The instance segmentation mask can then be applied to the depth map to extract the associated pixels. The object of interest may then be assumed to be object at substantially the center of the instance segmentation mask, and thus all of the corresponding pixels of the depth map are extracted to form the segmented object.

Another technique for segmenting the object relates to detecting a ground plane that the object of interest 12 is resting on, such as by detecting a flat plane of points adjacent to the shape that is at the center of the depth map, and selecting all points that are above that ground plane, where the upward direction may be determined based on identifying points that are between the ground plane and the scanning device and/or using information from an accelerometer in the dimensioning device 10. In a similar, manner to the technique using instance segmentation, in some embodiments the object of interest is assumed to be the object at substantially the center of the field of view of the depth map (e.g., other objects extending above the ground plane but located at the edges of the depth map and not connected to the points at the center of the depth map are ignored as not being part of the object of interest).

At 204, the processor renders the detected object and detected ground plane in a live view of the scene. Some aspects of embodiments of the present disclosure relate to providing a user with feedback regarding a detected ground plane that supports the object to be dimensioned. In some embodiments, the object dimensioning system computes the dimensions of an object by detecting the object (e.g., based on a point cloud of three-dimensional points that correspond to the object), and then computing the dimensions of the smallest six-sided box (or rectangular cuboid) having one face in contact with or aligned with the ground plane (where one other face is parallel to the ground plane and the four other faces are perpendicular to the ground plane).

Based on this constraint, the accuracy of the position of the computed ground plane relative to the object can affect the accuracy of the computed dimensions of the object (e.g., the height of the object). When the object is placed on a surface that makes it difficult to detect the ground plane (such as reflective surfaces containing specular highlights or repeating textures or dark surfaces that reflect little light that make it difficult for the depth reconstruction system to detect the ground plane) or where the correct ground plane might not be visible to the depth reconstruction system (e.g., the object is resting on a table, but the object hides or occludes the table from view, such that the contactless object dimensioning system detects the floor that the table is standing on as the ground plane).

Accordingly, aspects of embodiments of the present disclosure relate to providing augmented reality (AR) feedback regarding the detected location of the ground plane. Rather than trying to detect the plane as a three-dimensional (3-D) rectangular area with a well-defined 3-D position in the environment, some embodiments of the present disclosure relate to providing real-time feedback to the user about which part of the scene is considered the “ground” and the live quality of the ground detection. This is a simpler problem that does not require full reconstruction of the 3-D environment around the object and instead simplifies the problem to computing a 3-D plane (e.g., based on a few points around the object). As a result, the representation of the detected plane in the real-time augmented reality display dynamically adjusts and improves or degrades based on the viewpoint and various scene parameters in response to live changes made by the user (e.g., when repositioning the depth construction system and/or the object).

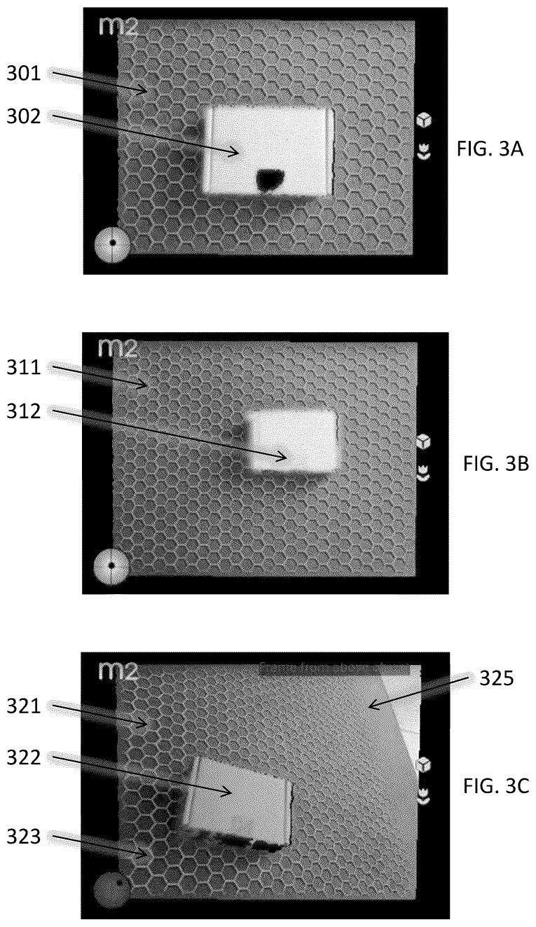

In some embodiments, the processor computes or detects the ground plane based on data generated by the depth reconstruction system as an indefinite plane where the object to be sized is located. As used herein, an indefinite plane is a plane where the plane is modeled based on the angles and the distance to the plane (e.g., relative to the depth reconstruction system or camera) but does not include a 3-D anchor point for the plane within the global coordinates corresponding to the scene. Instead, in some embodiments, the plane has the appearance of being “pinned” in 2-D to the bottom of the camera, where the positions of the mesh of the grid scales and tilts in the live view, but a point of the grid remains at the same location at the bottom center of the view. FIGS. 3A, 3B, and 3C are screenshots depicting a live view portion of a user interface for a dimensioning device according to one embodiment of the present disclosure, where the user interface shows a rendered grid corresponding to a detected ground plane and a rendered object corresponding to a detected object on the ground plane. As shown in FIG. 3A and FIG. 3B, the plane is rendered as a hexagonal grid, where the holes of the rendered grid show the live image of the actual surface (e.g., the color of the actual surface, as captured by the camera). FIG. 3A shows that the appearance of the rendering of the grid 301 changes as the depth reconstruction system is closer to the object 302 (as shown in FIG. 3A, where the hexagons of the grid 301 appear larger) and FIG. 3B shows that the grid 311 is rendered with smaller hexagons when the depth reconstruction system is farther from the object 312 (as shown in FIG. 3B, where the hexagons of the grid 311 appear smaller than the grid 301 shown in FIG. 3A). In addition, FIG. 3C shows that the grid 321 is rendered to appear tilted (according to the plane) when the user tilts the depth reconstruction system relative to the object 322 (e.g., in FIG. 3C, where the camera is moved to a lower angle with respect to the object, portions 323 of the ground plane that are closer to the camera are rendered with larger hexagons and portions 325 of the ground plane that are farther are rendered with smaller hexagons in accordance with three-dimensional perspective).

At 205, the processor determines problems in the framing of the object in the field of view of the depth reconstruction system, and, at 206, the processor augments the live view image of the scene with the rendered detected object and the ground plane and information regarding the detected framing problems (if any) and displays the rendered user interface on the display device 130. Specific examples of framing problems and information that is displayed in the live view based on these framing problems will be presented in more detail below.

For example, FIGS. 3A, 3B, and 3C further illustrate examples where the computer system applies an augmented reality overlay in the live view to highlight the selected object using different (transparent) colors based on the quality of the view for purposes of dimensioning. In the example of FIG. 3A, 3B, and 3C, the object that is being dimensioned is a cardboard box. FIG. 3A and FIG. 3B, the standard color of the cardboard box (e.g., brown) is changed to yellow (e.g., overlaid or augmented with a captured 3-D model of the box rendered in transparent yellow as shown in object 302 of FIG. 3A and 312 of FIG. 3B) to indicate that the cardboard box is framed well within the field of view of the depth reconstruction system. On the other hand, in FIG. 3C, where the depth reconstruction system has been moved to capture a lower angle perspective of the cardboard box 322, the cardboard box is overlaid with a different color (e.g., augmented with a captured 3-D model of the box rendered in transparent red) to indicate that the current view of the object 322 is poor for the purpose of computing the dimensions of the object 322. This provides the user with additional feedback regarding the framing of the object that is being dimensioned within the field of view of the depth reconstruction system.

Some aspects of embodiments of the present disclosure relate to methods for adjusting the size of the grid as it moves closer or farther away from the camera or depth reconstruction system. These aspects of embodiments of the present disclosure relate to addressing multiple considerations. On one hand, users expect the grid to scale appropriately with the plane's distance to give an impression of natural movement. On the other hand, scaling with distance can cause the grid to become either too small (too dense, thereby obscuring the color or appearance of the actual plane beneath) or too large (too sparse, thereby providing insufficient information to the user regarding the computed ground plane). To address this, aspects of embodiments of the present disclosure also relate to dynamically adjusting the grid size based on constraining the minimum and maximum size of the grid and by regulating how quickly the size of the grid changes in relation to the distance.

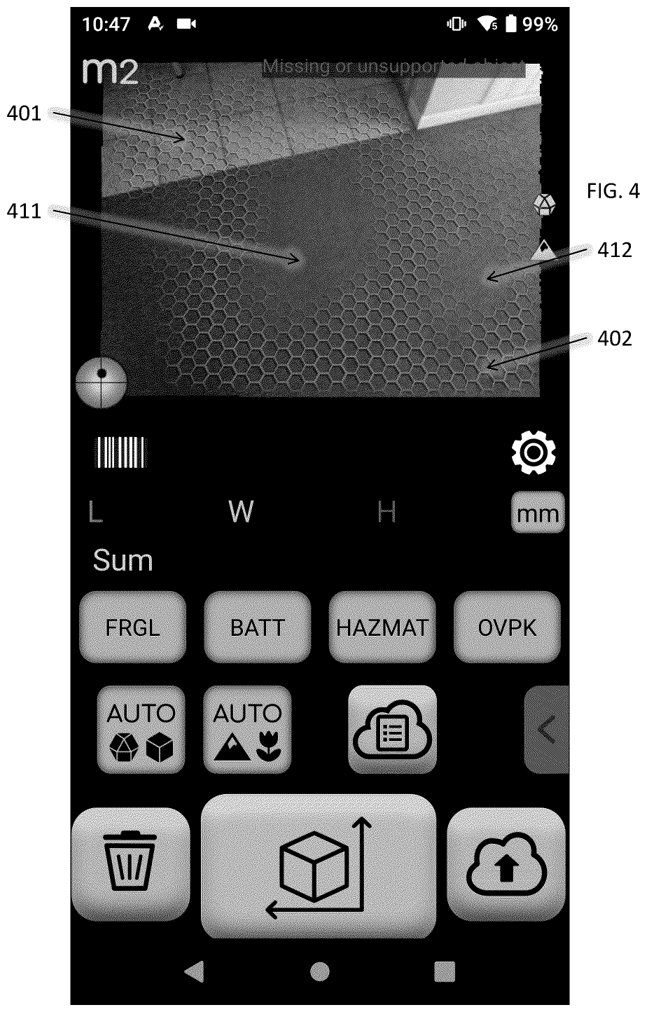

FIG. 4 is a screenshot of a user interface, according to one embodiment of the present disclosure, where the user interface shows uneven transparency of a rendered grid, representing different levels of certainty regarding the detection of a ground plane. In some embodiments of the present disclosure, as seen in FIG. 4, the transparency of the rendered grid 400 varies based on the quality of the ground plane detection in the area. The poorer the detection is in an area, the more transparent the grid appears in that area. In some embodiments, checking the quality of the detected ground plane includes determining the number (or density) of inliers (points that belong to the plane) and the deviations from the plane (e.g., how far above or below the detected ground plane those points are). A larger number of deviations from the plane indicates greater uncertainty regarding the detected ground plane. In some embodiments, the variance (or standard deviation) of the points is used to measure the quality of the detection of the ground plane, where low variance (or low standard deviation) indicates a high quality of detection of the ground plane, and a high variance (or high standard deviation) indicates a low quality of detection of the ground plane.

For example, while the grid is readily visible in regions 401 and 402 of FIG. 4, the grid is not visible in regions 411 and 412, indicating poor detection of the ground plane in those regions. The variability in quality of ground detection may depend on characteristics such as the characteristics of the material of the ground (e.g., matte materials versus glossy materials such as polished metal or highly non-reflective materials as dark carpet), flatness of the ground, and specular effects (e.g. glare from overhead lights). As such, a user can adjust the position of the scanning device, or add or remove supplemental lighting (e.g., by turning on the projection source 106, providing other external lighting, moving the object to an area with brighter external lighting, or moving the object to a location with less external lighting, such as to avoid overwhelming the active projection source 106), or more the object to a more suitable surface (e.g., moving the object from an uneven or deformable surface, such as on top of a protective blanket or packing materials and onto a flatter surface such as a poured concrete floor) to improve the quality of detection of the ground plane.

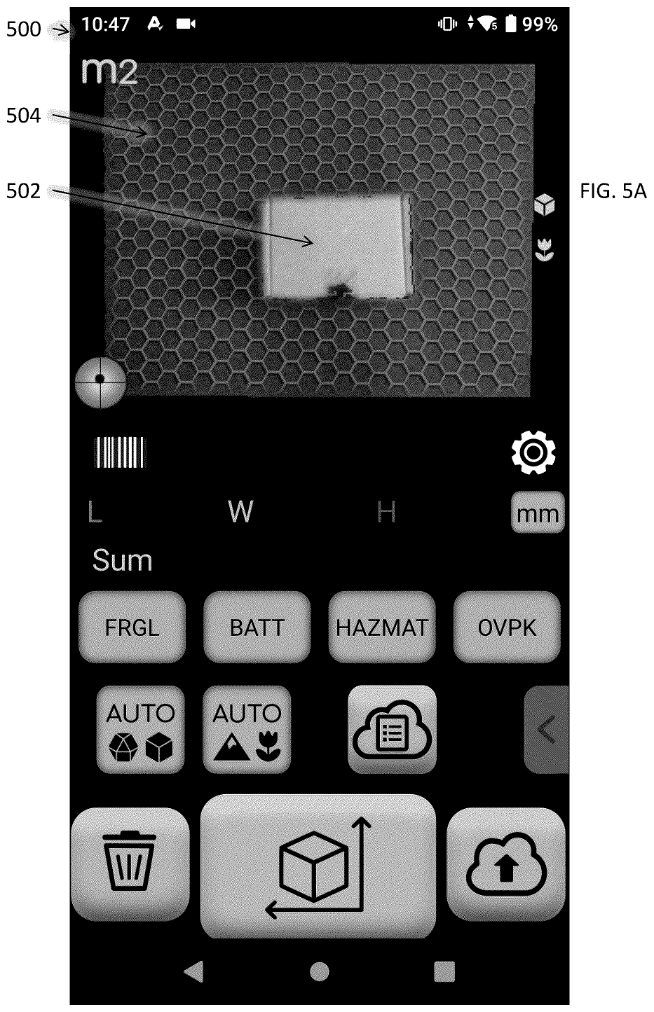

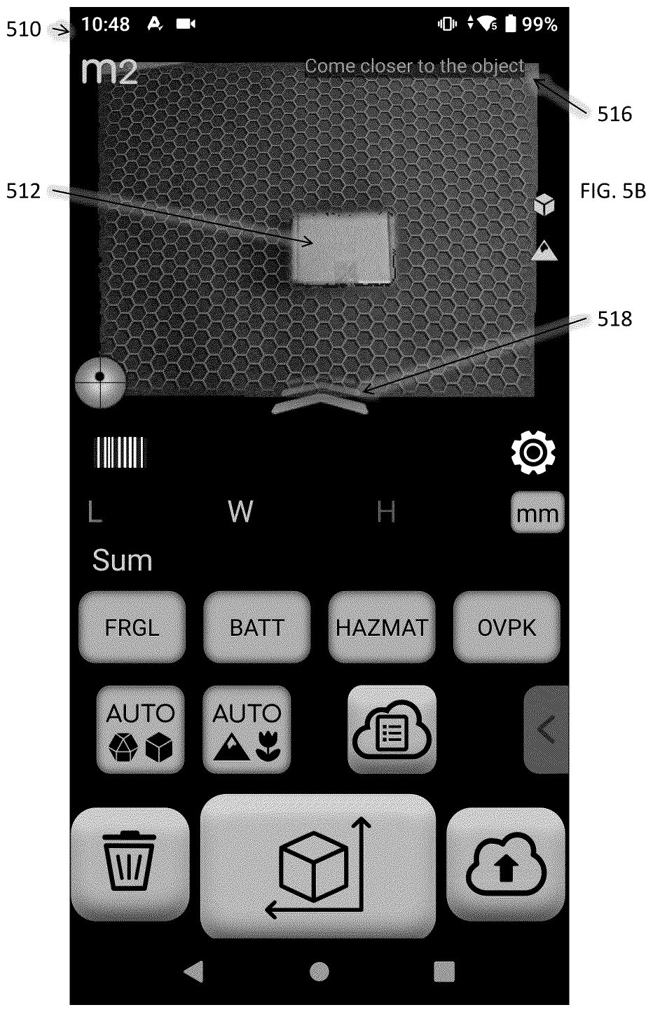

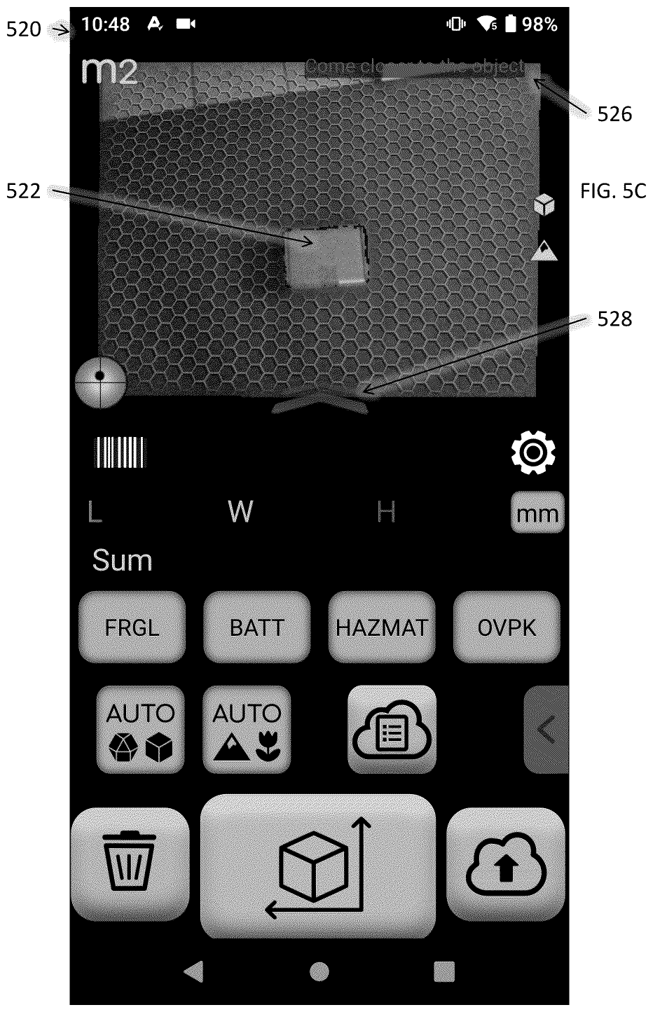

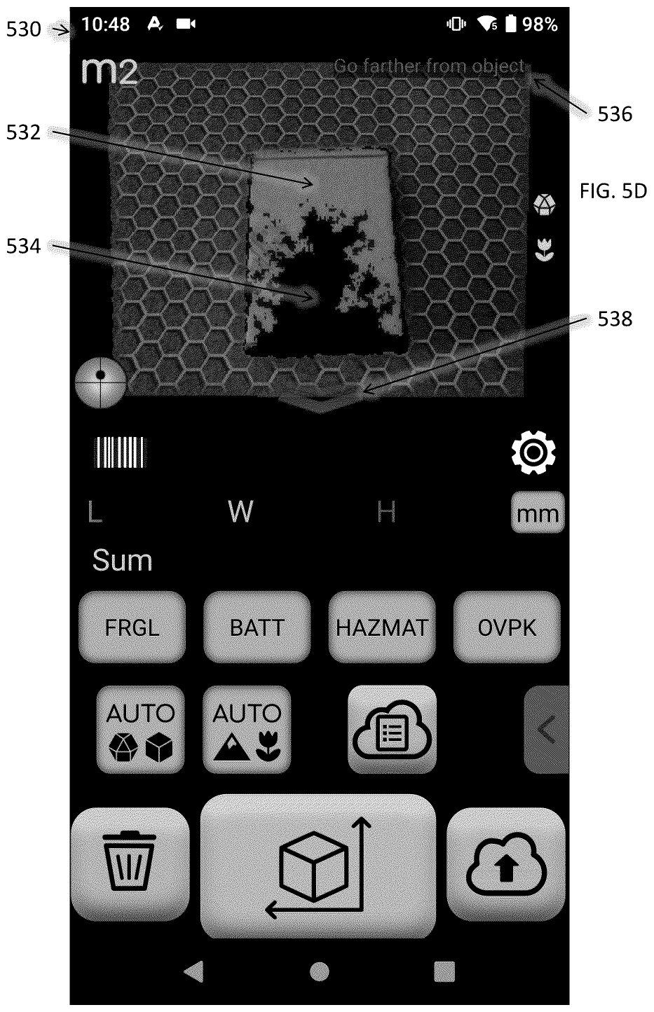

Some additional aspects of embodiments of the present disclosure relate to detecting issues or problems in the framing of the object and providing feedback regarding the detected issues or problems. FIGS. 5A, 5B, 5C, and 5D depict user interfaces, according to some embodiments of the present disclosure, with respective examples of instances where an object is framed acceptably based on distance, framed acceptably but with warnings based on being too distant from the object, framed unacceptably based on being too distant from the object, and framed unacceptably based on being too close to the object.

Some aspects of embodiments of the present disclosure relate to highlighting the object using different colors based on the quality of the detection of the object. In some embodiments, the object is colored a first color (e.g., yellow) when the framing conditions are good for computing the dimensions of the object. FIG. 5A is a screenshot of a user interface 500 depicting an example of an instance where the object 502 is framed in an acceptable manner and the object is highlighted, by augmenting the live image captured by the camera, in this first color of yellow. FIG. 5A includes a grid 504 as described above depicting the detected location of the ground plane supporting the object 502. FIG. 5B is a screenshot of a user interface 510 in a case where the scanning device (e.g., the depth reconstruction system) is farther from the object 512 than in the case of FIG. 5A, and therefore a warning condition is detected, indicating a suboptimal, but still acceptable, viewpoint or framing of the object, and therefore the object 512 is colored in a second color or warning color (e.g., orange). FIG. 5C is a screenshot of a user interface 520 in a case where the scanning device is too far from the object 522 to capture data for an accurate imaging and therefore the object 522 is highlighted in a third color or error color (e.g., overlaid in the live view with an error color such as red) to indicate a condition that prevents scanning. In some embodiments, in this condition that prevents scanning, the user interface disables the functionality that causes the measured dimensions to be captured and displayed to the user and/or recorded (e.g., to a database or other data storage format, either locally on the scanning device or on a remote data storage device such as a network-connected computer).

Some aspects of embodiments of the present disclosure further relate to displaying visual feedback (e.g., text messages or other indicators) to identify the framing error (or the most severe error when multiple errors are present) that the user should resolve to capture accurate dimensions of the object. As noted above, in the examples of FIG. 5B and FIG. 5C, the scanning device has been moved farther from the object, thereby resulting in poorer quality measurements. In some embodiments, the processor determines, at 205, that an object is too far away if its length in pixels within the frame falls below a threshold and its 3D points (e.g., the portions of the depth map corresponding to the object) are at least a threshold distance from a minimum working distance of the depth reconstruction system. As such, the message “come closer to the object” 516 and 526 is displayed in the user interface shown in FIG. 5B and FIG. 5C to indicate that the user can resolve the problem by moving closer to the object being scanned.

FIG. 5D depicts another example where the user is too close to the object for the object dimensioning system to compute accurate dimensions and therefore the user interface shows the message “go farther from the object” 536 to indicate that the user should move away from the object. In the example of FIG. 5D, portions of the object 532 are too close to the depth reconstruction system (e.g., closer than a minimum working distance), thereby causing the depth reconstruction to fail, as indicated by the holes 534 in the reconstructed 3-D model, as indicated in FIG. 5D as black regions of the box 532. In some embodiments, a processor determines, at 205, that an object is too close when some 3-D points of the object are closer than a defined threshold (e.g., within a defined threshold distance of the minimum working distance) or if parts of the object are touching (or in close proximity to) two opposite edges of the frame or field-of-view of the depth reconstruction system.

In some embodiments of the present disclosure, in addition to or instead of text messages regarding moving closer to or away from the object, the visual feedback includes an augmented reality symbol that is shown in the user interface to direct the user to move closer to (shown in FIG. 5B and FIG. 5C as upward pointing arrow or chevrons 518 and 528) or farther from the object (shown in FIG. 5D as downward pointing arrow or chevrons 538) for improved scanning of the object.

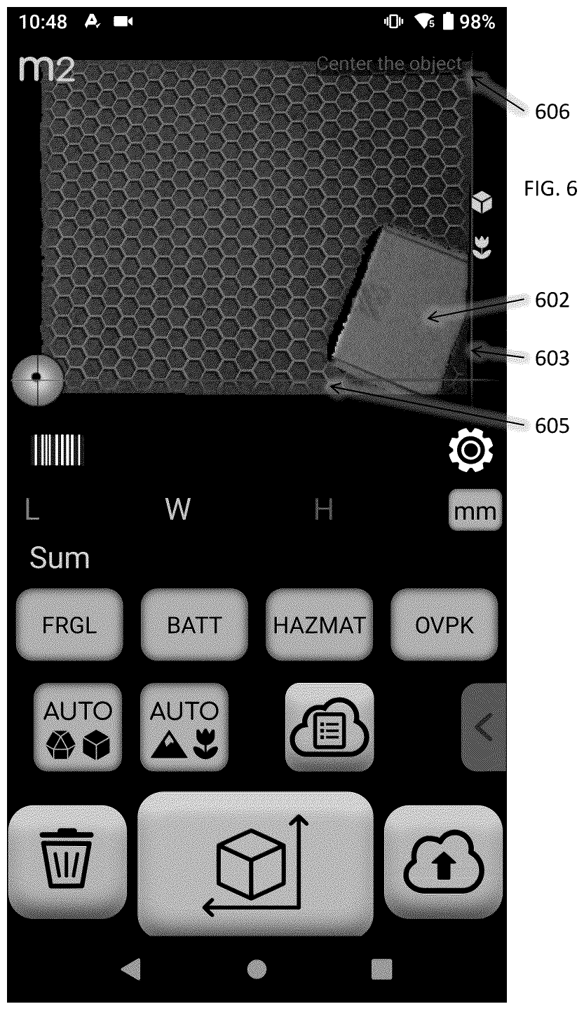

FIG. 6 depicts a user interface, according to some embodiments of the present disclosure, displaying error feedback when an object is framed too close to edges of the field of view of the scanning device. For example, a processor may detect, at 502, that an object needs to be centered if any of its pixels extend beyond a predefined border (e.g., slightly smaller than the entire frame or field-of view) or if its 2-D bounding box has any vertices outside the frame. In some embodiments, as shown in FIG. 6, when an object 602 is detected as being too close to, or extending past, an edge of the field of view of the contactless object dimensioning system, the processor displays a line highlighting the corresponding edge of the screen and/or, in some embodiments, highlighting a portion of the object that is exiting the field of view of the depth reconstruction system (e.g., a corner of the object that is shown as being close to the edge of the live view). In the example of FIG. 6, the object is too close to both the right edge and the bottom edge of the field of view of the object dimensioning system and therefore warnings are displayed with lines at the right 603 and bottom 605 sides of the live display. In addition, FIG. 6 shows that the object is highlighted in the error color (e.g., red) and that a message “Center the object” 606 is displayed to guide the user to the correct solution to the current framing issue or problem.

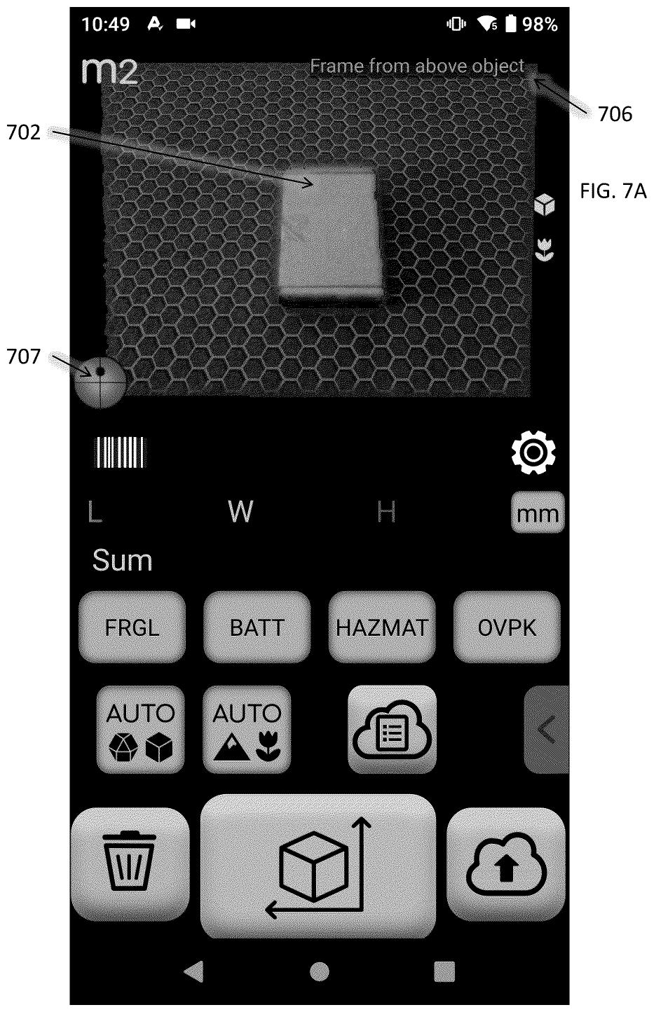

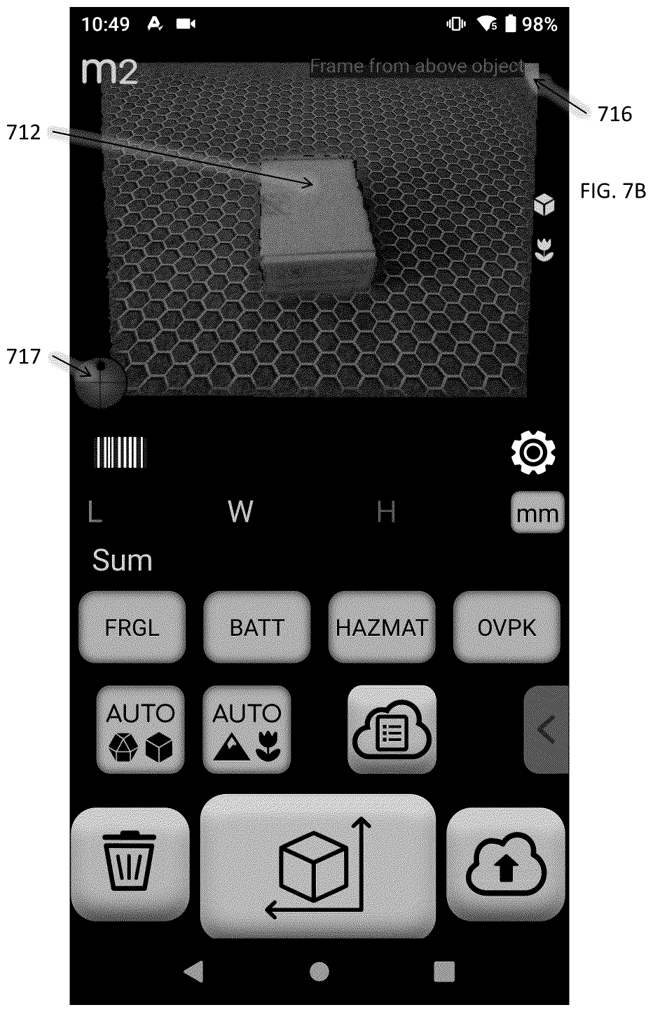

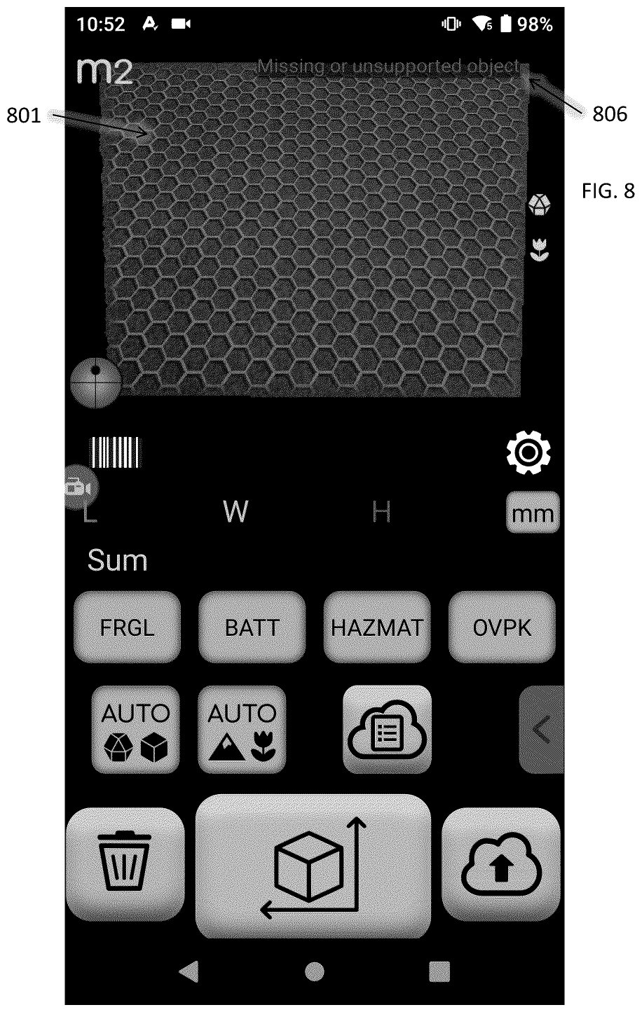

FIGS. 7A and 7B depict user interfaces, according to some embodiments of the present disclosure in which accuracy of scanning is improved when scanning the object from above, where an object is framed acceptably but with warnings due to a low angle and where an object is framed unacceptably due to a low angle. Some aspects of embodiments of the present disclosure also relate to showing a user interface element similar to a bubble level. As noted above, in some object dimensioning systems, the highest quality results are obtained when the scanning device is above the object being dimensioned (e.g., to reduce self-occlusion). The bubble level user interface element may be updated based an orientation of the scanning device relative to the ground plane (e.g., the normal direction of the ground plane) and/or, in some embodiments based on measurements from the IMU and provides feedback regarding the angle or orientation of the scanning device (e.g., when the tilt is too high). In some embodiments, the tilt is computed based on a computed relative angle between the detected ground plane and the orientation of the depth reconstruction system, where the depth reconstruction system is oriented such that its optical axis is within a threshold angle of being perpendicular to the detected ground plane. As shown in FIG. 7A, when the scanning device is not sufficiently above the object 702, the object and the bubble level 707 may be highlighted in the warning color (e.g., the same warning color, such as orange) and a message may be displayed such as “frame from above object” 706. As shown in FIG. 7B, when the object is framed from an even lower angle, then the object 712 and the bubble level 717 may be highlighted in the error color (e.g., the same warning color, such as red) and the processor may display the message “frame from above object” 716 to suggest that the user reposition the scanning device accordingly.

FIG. 8 depicts a user interface, according to some embodiments of the present disclosure, where feedback is provided to the user in a case where no object is detected in the field of view of the scanning device. While the prior examples showed cases where messages were shown alongside rendered models of the environment (e.g., the rendered grid and the rendered highlighting of the object), some error conditions, such as “missing object” 806, trigger a text alert without accompanying AR feedback in the form of highlighting an object. The example shown in FIG. 8 includes some AR feedback in the form of a hexagonal grid 801 representing a detected ground plane in the field of view of the object dimensioning system.

While the description above presented examples of objects that could easily fit within the field of view of the object dimensioning system, embodiments of the present disclosure are not limited thereto. Some aspects of embodiments of the present disclosure relate to providing augmented reality feedback when scanning objects that may not readily fit within the field of view of the object dimensioning system at the practical working distances of the object dimensioning system.

For example, in the context of logistics and the transportation of physical goods, many items may be bundled together into a unit load and placed on a pallet (or skid). One example of a pallet is a North American pallet (or GMA pallet) with typical dimensions of 48″ by 40″. The unit load of objects (e.g., boxed consumer goods) may be stacked on the pallet (or palletized) to form a large object that may be several feet tall. The height of the palletized item may make it difficult to obtain a top view of the pallet using a (handheld) object dimensioning system according to embodiments of the present disclosure, and therefore the large object may be scanned from a relatively low angle (e.g., from a viewpoint slightly above the object or from a viewpoint slightly below the top of the object) to compute the dimensions of the object. Furthermore, available viewpoints for scanning the objects may mean that some parts of the object (such as the rear of the object, relative to the position of the depth reconstruction system) will be hidden from view (e.g., self-occluded).

To improve the quality of scan and therefore the accuracy of the computed dimensions, the user may capture multiple images and/or depth maps of the large object and the surrounding environment from multiple viewpoints. For example, after capturing an image or depth map of two front sides of the object and the top of the object, the shapes of the remaining two sides of the object (on the back side of the object) remain ambiguous. The user may then move to the back side of the object to capture one or more additional images or depth maps of those other sides of the object. In some embodiments, the multiple scans of the object captured from the multiple different viewpoints are merged to generate a three-dimensional (3-D) model of the full object, and the dimensions of the object are computed based on the merged 3-D model.

As such, aspects of embodiments of the present disclosure relate to generating augmented reality (AR) feedback for directing the scanning of objects that are too large to fit within the field of view of the depth reconstruction system within a working distance of the depth reconstruction system.

A depth reconstruction may be constrained to a designed working distance range having a minimum working distance and a maximum working distance. For example, a stereo depth reconstruction system includes a stereo pair of cameras that are spaced apart along a baseline. Stereo depth reconstruction operates based on detecting a parallax shift caused by the slightly different viewpoints of the cameras, where a larger shift indicates that some part of the scene is closer and a smaller shift indicates a part of the scene that is farther. However, the accuracy of the depth measurements degrades at longer distances because the parallax shift becomes smaller. A longer baseline between the cameras can increase the working distance but can make the depth reconstruction system larger and unwieldy. On the other hand, when an object is too close to the stereo cameras, the views of the object may be too different for the system to automatically find matching or corresponding pixels for accurate depth reconstruction. As another example, the working distance of an active depth reconstruction system may be limited based on the power of light that can be emitted by the projection source.

A user may also be practically limited or constrained by the amount of physical space available around the object. In cramped working conditions, it may not be possible for the user to place the depth reconstruction system far enough away from the object being scanned to capture the full object within the field of view (e.g., based on the presence of walls or other objects in the area).

Accordingly, some aspects of embodiments of the present disclosure relate to detecting conditions where captures of the scene from multiple viewpoints may be needed for computing the dimensions of an object and providing augmented reality feedback to guide a user in the capture of the 3-D shape of the object from multiple viewpoints.

In some embodiments, detecting the conditions to operate in a mode for capturing multiple viewpoints is performed at step 205 of method 200 shown in FIG. 2. One example of a condition relates to detecting that the object is too large to fit within the field of view while remaining within the working distance of the depth reconstruction system. For example, the depth reconstruction system may track the distance to the object that is selected for dimensioning and determine that the object also extends beyond opposite sides of the field of view of the depth reconstruction system (e.g., beyond at least both the left and right sides of the field of view) when at or near the maximum working distance.

Another example of a condition is a case where the object being dimensioned extends beyond the opposite sides of the field of view, which may prompt the system to provide feedback to center the object and/or move farther from the object (e.g., with downward pointing arrow or chevrons such as those shown in FIG. 5D), but where the user, instead, moves the scanning device in a generally lateral direction to capture images of other portions or sides of the object.

In some embodiments, the computer system detects a condition for switching to a multiple viewpoints mode based on automatically detecting the content of a scene. In some embodiments, a trained machine learning model (e.g., a convolutional neural network) is configured to perform classification and/or instance segmentation to identify objects in a scene and classify those objects. In some embodiments, detecting a pallet in a scene (e.g., a pallet below an object in the center of the field of view of the depth reconstruction system) automatically identifies the object being dimensioned as a large object and switches operation to the multiple viewpoints mode. In some embodiments, detecting other or additional types of objects trigger such a mode for capturing the 3-D shape of the object from multiple angles. Examples of other types of objects include placement of the object on a forklift or flatbed trailer (or other equipment for moving large objects), detection of a vehicle (e.g., automobile, boat, or airplane), and the like.

In some embodiments of the present disclosure, based on detecting these cases of problems where the object is too large to be framed entirely within the field of view of the depth reconstruction system, the processing circuit generates feedback for display on the display device regarding the framing problem (the object being too large) and also provides feedback or guidance to the user on capturing additional views of the object (e.g., images or depth maps of the object captured from additional viewpoints).In some embodiments, the feedback includes messages or arrows guiding the user to move the scanning device laterally (e.g., to the left and/or to the right), such as by displaying arrows to the left or right (with respect to gravity). As the scanning device is moved to the left or right, additional images and/or depth maps are captured of the object and merged with existing depth maps to generate a partial 3-D model of the object, and the guidance continues to direct the user to scan portions of the object to fill gaps or missing portions of the model. In some embodiments, the processing circuit uses information from an inertial measurement unit (IMU) 118 to track the movement of the scanning system (e.g., based on dead reckoning) to assist in determining whether the scanning device has moved to track all sides of the object.

In some embodiments, the feedback includes messages or arrows guiding a user to switch a device orientation, such as between a portrait mode (where the field of view is taller than it is wide) and a landscape mode (where the field of view is wider than it is tall). In more detail, wider and shorter objects may fit better within the framing of the field of view of the depth reconstruction system when the depth reconstruction system oriented with its field of view in a landscape mode, whereas taller objects may fit better within a field of view oriented in a portrait mode.

Some types of objects may have substantially cuboidal shapes, such as some types of items stacked on a pallet. In some embodiments, based on detecting an object having a cuboidal shape or an object stacked on a pallet, the feedback guides the user to align the field of view with a face of the object or a face (or side) of the pallet rather than capturing a 3-D scan or depth map from a corner.

Some aspects of embodiments of the present disclosure relate to loading different profiles that store different sets of parameters and/or thresholds for warnings and errors. These profiles can ensure and/or enforce varying levels of accuracy in the dimensioning process depending on how strict the thresholds are. For certain uses (e.g., legal for trade), users might be required to select a specific profile to ensure the device meets certification standards for that application (e.g., ensures that the scanning device captures high quality data regarding the object to compute sufficiently accurate measurements for the associated certification standards), where higher quality data may involve higher quality scans (e.g., better lighting), with a tradeoff of more thorough scans (e.g., holding the depth reconstruction system steady for a longer period or scanning around the object to obtain views of multiple sides of the object).

According to one embodiment of the present disclosure, a system includes: a depth reconstruction system; a display device; a processor; and memory storing instructions that when executed by the processor, cause the processor to: control the depth reconstruction system to capture a three-dimensional representation of a scene;

perform automatic object detection on the three-dimensional representation of the scene; detect a ground plane in the scene; render a model of the ground plane in a live view image of the scene; perform detection of problems in a framing of the scene in a field of view of the depth reconstruction system; and display, on the display device, the live view image of the scene augmented with the rendered model of the ground plane and one or more detected framing problems.

The model of the detected ground plane may be rendered with transparency proportional to a confidence in the detection of the ground plane in a corresponding portion of the live view image of the scene.

The model of the detected ground plane may be rendered as a grid having an apparent size that changes based on a distance between the ground plane and the depth reconstruction system, the distance being computed based on the three-dimensional representation of the scene, and the apparent size of the grid may have a maximum size when the distance is smaller than a first threshold distance and a minimum size when the distance is greater than a second threshold distance.

The performing the automatic object detection may detect an object in the scene, and the memory may further store instructions that, when executed by the processor, cause the processor to render a model of the object in the live view image of the scene.

The model of the object may be rendered in the live view image of the scene differently based on whether one or more problems are detected in the framing of the scene.

The object may be rendered in the live view image of the scene in a first color based on detecting one or more problems in the framing of the scene and in a second color different from the first color based on detecting no problems in the framing of the scene.

The detection of problems in the framing of the scene may detect that the object is too close to an edge of the field of view of the depth reconstruction system, and the live view image of the scene displayed on the display device may include an indicator at an edge of the display device corresponding to the edge of field of view of the depth reconstruction system that the object is too close to.

The detection of problems in the framing of the scene may detect that the object is at a low angle with respect to the depth reconstruction system, and the live view image of the scene displayed on the display device may be augmented with a bubble level indicating a direction for the depth reconstruction system to be tilted with respect to the object to resolve the low angle.

The detection of problems in the framing of the scene may detect that the object is at a distance outside a working distance range of the depth reconstruction system, and the live view image of the scene displayed on the display device may be augmented with an indicator of a direction for the depth reconstruction system to be moved with respect to the object such that the object is within the working distance range of the depth reconstruction system.

The detection of problems in the framing of the scene may detect that the object is larger than the field of view of the depth reconstruction system, and the live view image of the scene displayed on the display device may be augmented with an indicator of a direction for the depth reconstruction system to be moved with respect to the object to capture one or more additional three-dimensional representations of the scene from additional viewpoints.

According to one embodiment of the present disclosure, a non-transitory computer-readable medium stores instructions that, when executed by a processor, cause the processor to: receive a three-dimensional representation of a scene captured by a depth reconstruction system; perform automatic object detection on the three-dimensional representation of the scene; detect a ground plane in the scene; render a model of the ground plane in a live view image of the scene; perform detection of problems in a framing of the scene in a field of view of the depth reconstruction system; and display the live view image of the scene augmented with the rendered model of the ground plane and one or more detected framing problems.

The model of the detected ground plane may be rendered with transparency proportional to a confidence in the detection of the ground plane in a corresponding portion of the live view image of the scene.

The model of the detected ground plane may be rendered as a grid having an apparent size that changes based on a distance between the ground plane and the depth reconstruction system, the distance being computed based on the three-dimensional representation of the scene, and the apparent size of the grid may have a maximum size when the distance is smaller than a first threshold distance and a minimum size when the distance is greater than a second threshold distance.

The performing the object detection may detect an object in the scene, and the non-transitory computer-readable medium may further store instructions that, when executed by the processor, cause the processor to render a model of the object in the live view image of the scene.

The model of the object may be rendered in the live view image of the scene differently based on whether one or more problems are detected in the framing of the scene.

The object may be rendered in the live view image of the scene in a first color based on detecting one or more problems in the framing of the scene and in a second color different from the first color based on detecting no problems in the framing of the scene.

The detection of problems in the framing of the scene may detect that the object is too close to an edge of the field of view of the depth reconstruction system, and the live view image of the scene may include an indicator at an edge of the live view image corresponding to the edge of field of view of the depth reconstruction system that the object is too close to.

The detection of problems in the framing of the scene may detect that the object is at a low angle with respect to the depth reconstruction system, and the live view image of the scene may be augmented with a bubble level indicating a direction for the depth reconstruction system to be tilted with respect to the object to resolve the low angle. The detection of problems in the framing of the scene may detect that the object

is at a distance outside a working distance range of the depth reconstruction system, and the live view image of the scene may be augmented with an indicator of a direction for the depth reconstruction system to be moved with respect to the object such that the object is within the working distance range of the depth reconstruction system.

The detection of problems in the framing of the scene may detect that the object is larger than the field of view of the depth reconstruction system, and the live view image of the scene may be augmented with an indicator of a direction for the depth reconstruction system to be moved with respect to the object to capture one or more additional three-dimensional representations of the scene from additional viewpoints.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A system comprising:
a depth reconstruction system;
a display device;
a processor; and
memory storing instructions that when executed by the processor, cause the processor to:
control the depth reconstruction system to capture a three-dimensional representation of a scene;
perform automatic object detection on the three-dimensional representation of the scene;
detect a ground plane in the scene;
render a model of the ground plane in a live view image of the scene;
perform detection of problems in a framing of the scene in a field of view of the depth reconstruction system; and
display, on the display device, the live view image of the scene augmented with the rendered model of the ground plane and one or more detected framing problems.

2. The system of claim 1, wherein the model of the detected ground plane is rendered with transparency proportional to a confidence in the detection of the ground plane in a corresponding portion of the live view image of the scene.

3. The system of claim 1, wherein the model of the detected ground plane is rendered as a grid having an apparent size that changes based on a distance between the ground plane and the depth reconstruction system, the distance being computed based on the three-dimensional representation of the scene, and
wherein the apparent size of the grid has a maximum size when the distance is smaller than a first threshold distance and a minimum size when the distance is greater than a second threshold distance.

4. The system of claim 1, wherein performing the automatic object detection detects an object in the scene, and
wherein the memory further stores instructions that, when executed by the processor, cause the processor to render a model of the object in the live view image of the scene.

5. The system of claim 4, wherein the model of the object is rendered in the live view image of the scene differently based on whether one or more problems are detected in the framing of the scene.

6. The system of claim 4, wherein the object is rendered in the live view image of the scene in a first color based on detecting one or more problems in the framing of the scene and in a second color different from the first color based on detecting no problems in the framing of the scene.

7. The system of claim 4, wherein the detection of problems in the framing of the scene detects that the object is too close to an edge of the field of view of the depth reconstruction system, and
wherein the live view image of the scene displayed on the display device includes an indicator at an edge of the display device corresponding to the edge of field of view of the depth reconstruction system that the object is too close to.

8. The system of claim 1, wherein the detection of problems in the framing of the scene detects that the object is at a low angle with respect to the depth reconstruction system, and
wherein the live view image of the scene displayed on the display device is augmented with a bubble level indicating a direction for the depth reconstruction system to be tilted with respect to the object to resolve the low angle.

9. The system of claim 1, wherein the detection of problems in the framing of the scene detects that the object is at a distance outside a working distance range of the depth reconstruction system, and
wherein the live view image of the scene displayed on the display device is augmented with an indicator of a direction for the depth reconstruction system to be moved with respect to the object such that the object is within the working distance range of the depth reconstruction system.

10. The system of claim 1, wherein the detection of problems in the framing of the scene detects that the object is larger than the field of view of the depth reconstruction system, and
wherein the live view image of the scene displayed on the display device is augmented with an indicator of a direction for the depth reconstruction system to be moved with respect to the object to capture one or more additional three-dimensional representations of the scene from additional viewpoints.

11. A non-transitory computer-readable medium storing instructions that, when executed by a processor, cause the processor to:
receive a three-dimensional representation of a scene captured by a depth reconstruction system;
perform automatic object detection on the three-dimensional representation of the scene;
detect a ground plane in the scene;
render a model of the ground plane in a live view image of the scene;
perform detection of problems in a framing of the scene in a field of view of the depth reconstruction system; and
display the live view image of the scene augmented with the rendered model of the ground plane and one or more detected framing problems.

12. The non-transitory computer-readable medium of claim 11, wherein the model of the detected ground plane is rendered with transparency proportional to a confidence in the detection of the ground plane in a corresponding portion of the live view image of the scene.

13. The non-transitory computer-readable medium of claim 11, wherein the model of the detected ground plane is rendered as a grid having an apparent size that changes based on a distance between the ground plane and the depth reconstruction system, the distance being computed based on the three-dimensional representation of the scene, and
wherein the apparent size of the grid has a maximum size when the distance is smaller than a first threshold distance and a minimum size when the distance is greater than a second threshold distance.

14. The non-transitory computer-readable medium of claim 11, wherein performing the object detection detects an object in the scene, and
wherein the non-transitory computer-readable medium further stores instructions that, when executed by the processor, cause the processor to render a model of the object in the live view image of the scene.

15. The non-transitory computer-readable medium of claim 14, wherein the model of the object is rendered in the live view image of the scene differently based on whether one or more problems are detected in the framing of the scene.

16. The non-transitory computer-readable medium of claim 14, wherein the object is rendered in the live view image of the scene in a first color based on detecting one or more problems in the framing of the scene and in a second color different from the first color based on detecting no problems in the framing of the scene.

17. The non-transitory computer-readable medium of claim 14, wherein the detection of problems in the framing of the scene detects that the object is too close to an edge of the field of view of the depth reconstruction system, and
wherein the live view image of the scene comprises an indicator at an edge of the live view image corresponding to the edge of field of view of the depth reconstruction system that the object is too close to.

18. The non-transitory computer-readable medium of claim 11, wherein the detection of problems in the framing of the scene detects that the object is at a low angle with respect to the depth reconstruction system, and
wherein the live view image of the scene is augmented with a bubble level indicating a direction for the depth reconstruction system to be tilted with respect to the object to resolve the low angle.

19. The non-transitory computer-readable medium of claim 11, wherein the detection of problems in the framing of the scene detects that the object is at a distance outside a working distance range of the depth reconstruction system, and
wherein the live view image of the scene is augmented with an indicator of a direction for the depth reconstruction system to be moved with respect to the object such that the object is within the working distance range of the depth reconstruction system.

20. The non-transitory computer-readable medium of claim 11, wherein the detection of problems in the framing of the scene detects that the object is larger than the field of view of the depth reconstruction system, and
wherein the live view image of the scene is augmented with an indicator of a direction for the depth reconstruction system to be moved with respect to the object to capture one or more additional three-dimensional representations of the scene from additional viewpoints.
